(19) United States
(12) Patent Application Publication
(10) Pub. No.: US 2025/0047221 A1
(43) Pub. Date: Feb. 6, 2025

(54) GATE DRIVE CIRCUIT, GATE DRIVE DEVICE, MOTOR SYSTEM, VEHICLE, AND CURRENT-CONSUMPTION REDUCING METHOD

(71) Applicant: ROHM CO., LTD., Kyoto (JP)

(72) Inventor: Takashi FUJIMURA, Kyoto (JP)

(21) Appl. No.: 18/793,059

(22) Filed: Aug. 2, 2024

(30) Foreign Application Priority Data
Aug. 2, 2023 (JP) 2023-126423

(51) Int. Cl. H02P 3/22

(52) U.S. Cl. CPC H02P 3/22

(57) ABSTRACT

A gate drive circuit is configured to drive a gate of a second switching device in a motor drive circuit, the motor drive circuit including a plurality of half-bridge circuits each including a first switching device, and the second switching device that is connected in series to the first switching device and that is provided on a low-potential side relative to the first switching device, the motor drive circuit being configured to drive a motor. The gate drive circuit includes: a current source unit that is configured to allow current to flow into the gate; and a current sink unit that is configured to draw current from the gate. The current source unit includes a first diode that is provided with an orientation in which a cathode of the first diode is directed to a side where the gate of the second switching device is present.

### CROSS-REFERENCE TO RELATED APPLICATIONS

This nonprovisional application claims priority under 35 U.S.C. § 119 (a) on Patent Application No. 2023-126423 filed in Japan on Aug. 2, 2023, the entire contents of which are hereby incorporated by reference.

### BACKGROUND OF THE INVENTION

### 1. Technical Field

The present disclosure relates to a gate drive circuit, a gate drive device, a motor system, a vehicle, and a current-consumption reducing method.

### 2. Description of Related Art

A motor driver that enables suppression of power consumption at a time of application of a short brake to a motor is disclosed in Japanese Patent Application Laid-open No. 2021-29084. In the motor driver shown in FIG. 8 of Japanese Patent Application Laid-open No. 2021-29084, at the time of the application of the short brake to the motor, a control logic unit shuts down both a high-side pre-driver and a low-side pre-driver.

### BRIEF DESCRIPTION OF THE DRAWINGS

FIG. 1 is a diagram showing a schematic configuration of a motor system according to a first embodiment;

FIG. 2 is an exterior perspective view of a gate drive device;

FIG. 3 is a diagram showing a schematic configuration of a motor system according to a second embodiment;

FIG. 4 is a diagram showing a schematic configuration of a motor system according to a third embodiment;

FIG. 5 is a diagram showing a schematic configuration of a motor system according to a fourth embodiment;

FIG. 6 is a diagram showing an example of a configuration of a brake circuit;

FIG. 7 is a diagram showing an example of configurations of a control circuit and a power supply;

FIG. 8 is a view illustrating an exterior appearance of a vehicle; and

FIG. 9 is a schematic view illustrating an example of a configuration of a power window system to which the motor systems are applied.

### DETAILED DESCRIPTION

Herein, a MOSFET (Metal-Oxide-Semiconductor Field Effect Transistor) refers to a field-effect transistor with a gate structure constituted by at least three layers of “a layer formed of a conductor or a semiconductor such as polysilicon with a small resistance value,” “an insulating layer,” and “a P-type, an N-type, or an intrinsic semiconductor layer.” In other words, the gate structure of the MOSFET is not limited to a three-layer structure constituted by a metal, an oxide, and a semiconductor.

### First Embodiment

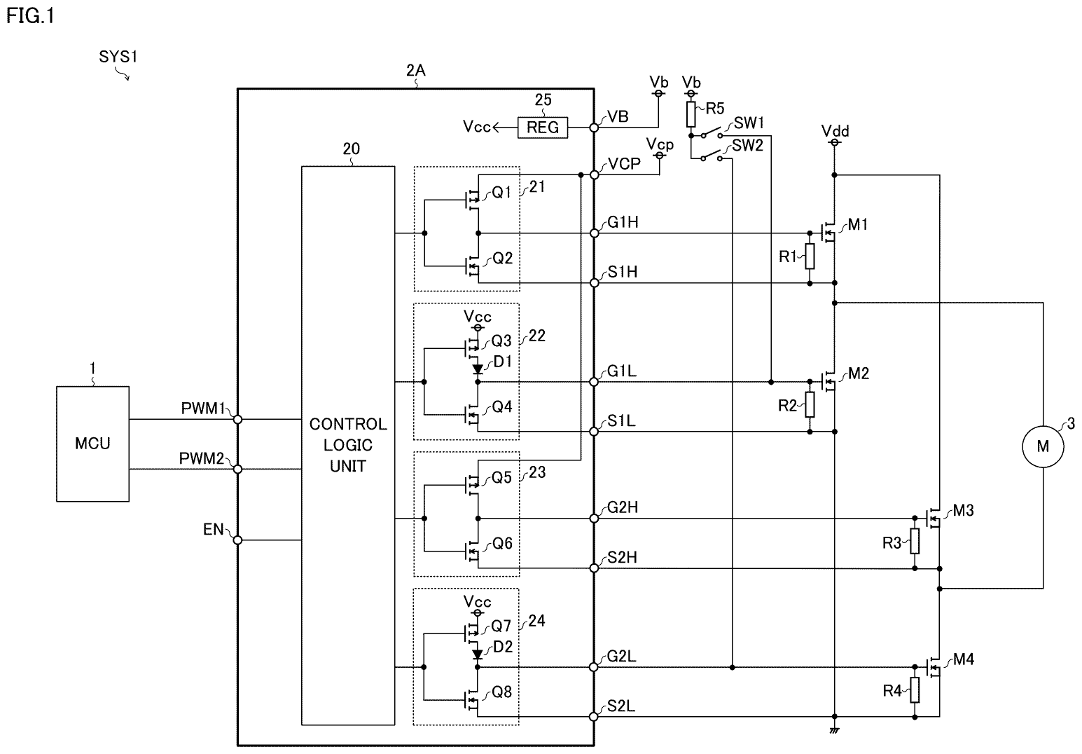

FIG. 1 is a diagram showing a schematic configuration of a motor system according to a first embodiment. This motor system SYS1 shown in FIG. 1 includes an MCU (Micro Controller Unit) 1, a gate drive device 2A, a first half-bridge circuit including switching devices M1 and M2, a second half-bridge circuit including switching devices M3 and M4, and a motor 3. The motor system SYS1 shown in FIG. 1 further includes resistors R1 to R5 and switches SW1 and SW2. A motor drive circuit that is constituted by the gate drive device 2A, the first half-bridge circuit, and the second half-bridge circuit drives the motor 3.

In this embodiment, the switching devices M1 to M4 are each an N-channel MOSFET. The switching device M2 is connected in series to the switching device M1, and is provided on a low-potential side relative to the switching device M1. The switching device M4 is connected in series to the switching device M3, and is provided on a low-potential side relative to the switching device M3.

The MCU 1 supplies a first PWM (Pulse Width Modulation) signal to a terminal PWM1 of the gate drive device 2A, and supplies a second PWM signal to a terminal PWM2 of the gate drive device 2A.

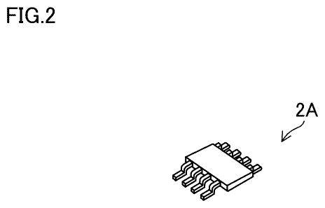

The gate drive device 2A is a semiconductor integrated-circuit device. FIG. 2 is an exterior perspective view of the gate drive device 2A. The gate drive device 2A is an electronic component formed by sealing a semiconductor integrated-circuit chip into a package made of a resin. A plurality of external terminals are provided to and exposed from the package of the gate drive device 2A, and the plurality of these external terminals include the terminal PWM1, the terminal PWM2, and terminals EN, VB, VCP, G1H, S1H, G1L, S1L, G2H, S2H, G2L, and S2L shown in FIG. 1. Note that, the number of the external terminals of the gate drive device 2A and an exterior appearance of the gate drive device 2A, the external terminals and the exterior appearance being illustrated in FIG. 2, are merely examples.

The gate drive device 2A includes a control logic unit 20, gate drive circuits 21 to 24, an internal power-supply circuit 25. The gate drive device 2A further includes the terminals PWM1, PWM2, EN, VB, VCP, G1H, S1H, G1L, S1L, G2H, S2H, G2L, and S2L.

The control logic unit 20 supplies a signal based on the first PWM signal to the gate drive circuits 21 and 22, the first PWM signal being supplied to the terminal PWM1. The control logic unit 20 supplies a signal based on the second PWM signal to the gate drive circuits 23 and 24, the second PWM signal being supplied to the terminal PWM2.

The internal power-supply circuit 25 converts a voltage Vb to a stabilized internal power-supply voltage Vcc, the voltage Vb being applied to the terminal VB. Under a state in which an enable signal to be applied to the terminal EN has been at a first level (for example, low level), the control logic unit 20 and the internal power-supply circuit 25 are in an enabled state. Meanwhile, under a state in which the enable signal to be applied to the terminal EN has been at a second level (for example, high level), the control logic unit 20 and the internal power-supply circuit 25 are in a disabled state.

The gate drive circuit 21 includes switching devices Q1 and Q2. The switching device Q1 is a P-channel MOSFET. The switching device Q2 is an N-channel MOSFET. The control logic unit 20 complementarily switches on and off the switching devices Q1 and Q2. The switching device Q1 is a current source unit configured to allow current to flow into a gate of the switching device M1. The switching device Q2 is a current sink unit configured to draw current from the gate of the switching device M1.

A source of the switching device Q1 is connected to the terminal VCP. On an outside of the gate drive device 2A, a voltage Vep is applied to the terminal VCP, and a voltage Vdd is applied to a drain of the switching device M1. The voltage Vep is a voltage higher than the voltage Vdd. A drain of the switching device Q1 and a drain of the switching device Q2 are connected to the terminal G1H. On the outside of the gate drive device 2A, the gate of the switching device M1 and a first end of the resistor R1 are connected to the terminal G1H. A source of the switching device Q2 is connected to the terminal S1H. On the outside of the gate drive device 2A, a source of the switching device M1, a second end of the resistor R1, a drain of the switching device M2, and a first end of the motor 3 are connected to the terminal S1H. Note that, the resistor R1 provided in this embodiment may be omitted.

The gate drive circuit 22 includes switching devices Q3 and Q4 and a diode D1. The switching device Q3 is a P-channel MOSFET. The switching device Q4 is an N-channel MOSFET. The control logic unit 20 complementarily switches on and off the switching devices Q3 and Q4. The switching device Q3 and the diode D1 constitute a current source unit configured to allow current to flow into a gate of the switching device M2. The switching device Q4 is a current sink unit configured to draw current from the gate of the switching device M2.

The internal power-supply voltage Vcc is applied to a source of the switching device Q3. An anode of the diode D1 is connected to a drain of the switching device Q3. A cathode of the diode D1 and a drain of the switching device Q4 are connected to the terminal G1L. On the outside of the gate drive device 2A, the gate of the switching device M2, a first end of the resistor R2, and a first end of the switch SW1 are connected to the terminal G1L. A source of the switching device Q4 is connected to the terminal S1L. On the outside of the gate drive device 2A, a source of the switching device M2, a second end of the resistor R2, and a ground potential are connected to the terminal S1L. Note that, the resistor R2 provided in this embodiment may be omitted.

The gate drive circuit 23 includes switching devices Q5 and Q6. The switching device Q5 is a P-channel MOSFET. The switching device Q6 is an N-channel MOSFET. The control logic unit 20 complementarily switches on and off the switching devices Q5 and Q6. The switching device Q5 is a current source unit configured to allow current to flow into a gate of the switching device M3. The switching device Q6 is a current sink unit configured to draw current from the gate of the switching device M3.

Similar to the source of the switching device Q1, a source of the switching device Q5 is connected to the terminal VCP. A drain of the switching device Q5 and a drain of the switching device Q6 are connected to the terminal G2H. On the outside of the gate drive device 2A, the gate of the switching device M3 and a first end of the resistor R3 are connected to the terminal G2H. A source of the switching device Q6 is connected to the terminal S2H. On the outside of the gate drive device 2A, a source of the switching device M3, a second end of the resistor R3, a drain of the switching device M4, and a second end of the motor 3 are connected to the terminal S2H. Note that, the resistor R3 provided in this embodiment may be omitted.

The gate drive circuit 24 includes switching devices Q7 and Q8 and a diode D2. The switching device Q7 is a P-channel MOSFET. The switching device Q8 is an N-channel MOSFET. The control logic unit 20 complementarily switches on and off the switching devices Q7 and Q8. The switching device Q7 and the diode D2 constitute a current source unit configured to allow current to flow into a gate of the switching device M4. The switching device Q8 is a current sink unit configured to draw current from the gate of the switching device M4.

The internal power-supply voltage Vec is applied to a source of the switching device Q7. An anode of the diode D2 is connected to a drain of the switching device Q7. A cathode of the diode D2 and a drain of the switching device Q8 are connected to the terminal G2L. On the outside of the gate drive device 2A, the gate of the switching device M4, a first end of the resistor R4, and a first end of the switch SW2 are connected to the terminal G2L. A source of the switching device Q8 is connected to the terminal S2L. On the outside of the gate drive device 2A, a source of the switching device M4, a second end of the resistor R4, and the ground potential are connected to the terminal S2L. Note that, the resistor R4 provided in this embodiment may be omitted.

A second end of the switch SW1 and a second end of the switch SW2 are connected to a second end of the resistor R5. The voltage Vb is applied to a first end of the resistor R5. Note that, voltage to be applied to the first end of the resistor R5 is not limited to the voltage Vb, and any other voltages that cause the switching device M2 to be turned on with the switch SW1 having been turned on and cause the switching device M4 to be turned on with the switch SW2 having been turned on may be applied.

Under a state in which the enable signal at the first level (for example, low level) has been supplied to the terminal EN, in response to control to cause the switch SW1 and the switch SW2 to be turned on, the switching devices M2 and M4 are turned on to apply a short brake to the motor 3. The diode D1 prevents flow of the current from the terminal G1L to the internal power-supply circuit 25 via a body diode of the switching device Q3. With this, current consumption at a time of the application of the short brake to the motor 3 is reduced. Similarly, the diode D2 prevents flow of the current from the terminal G2L to the internal power-supply circuit 25 via a body diode of the switching device Q7. With this, the current consumption at the time of the application of the short brake to the motor 3 is reduced.

### Second Embodiment

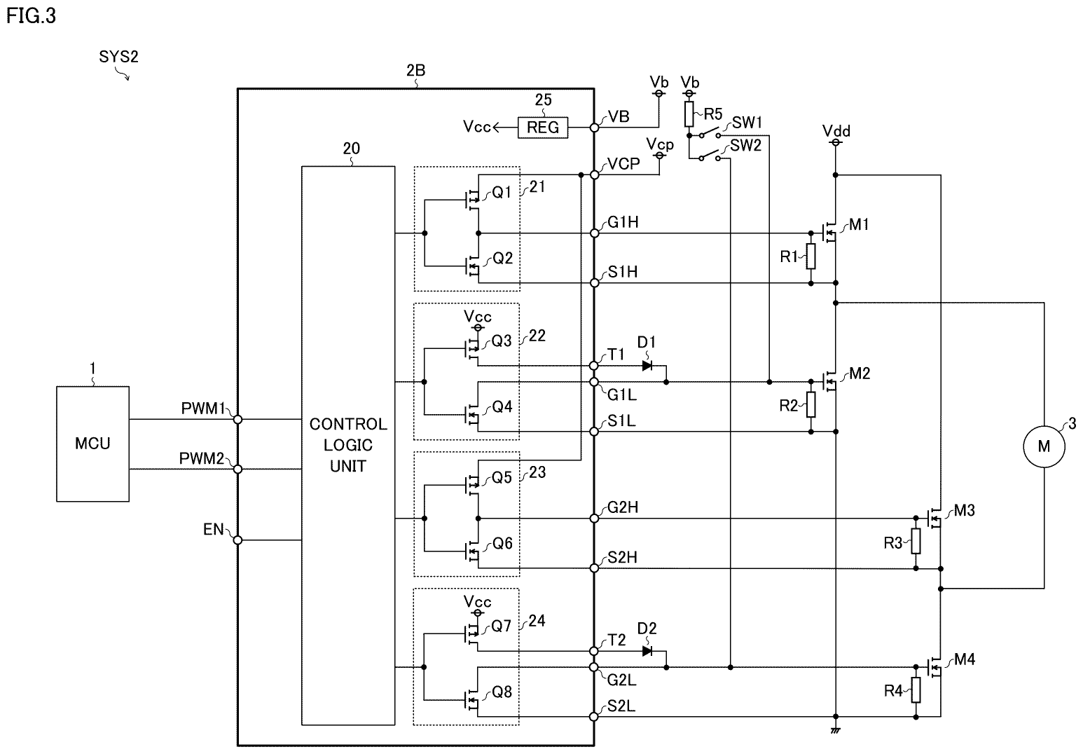

FIG. 3 is a diagram showing a schematic configuration of a motor system according to a second embodiment. This motor system SYS2 shown in FIG. 3 includes the MCU 1, a gate drive device 2B, the first half-bridge circuit including the switching devices M1 and M2, the second half-bridge circuit including the switching devices M3 and M4, and the motor 3. The motor system SYS2 shown in FIG. 3 further includes the diodes D1 and D2, the resistors R1 to R5, and the switches SW1 and SW2. A motor drive circuit that is constituted by the gate drive device 2B, the first half-bridge circuit, and the second half-bridge circuit drives the motor 3.

The gate drive device 2B is basically the same as the gate drive device 2A except for including terminals T1 and T2 instead of the diodes D1 and D2.

An electronic configuration of the motor system SYS2 shown in FIG. 3 is basically the same as an electronic configuration of the motor system SYS1 shown in FIG. 1. Thus, also in this embodiment, the diode D1 prevents the flow of the current from the terminal G1L to the internal power-supply circuit 25 via the body diode of the switching device Q3. With this, the current consumption at the time of the application of the short brake to the motor 3 is reduced. Similarly, the diode D2 prevents the flow of the current from the terminal G2L to the internal power-supply circuit 25 via the body diode of the switching device Q7. With this, the current consumption at the time of the application of the short brake to the motor 3 is reduced.

Note that, modifications of the first embodiment are applicable also to this embodiment.

### Third Embodiment

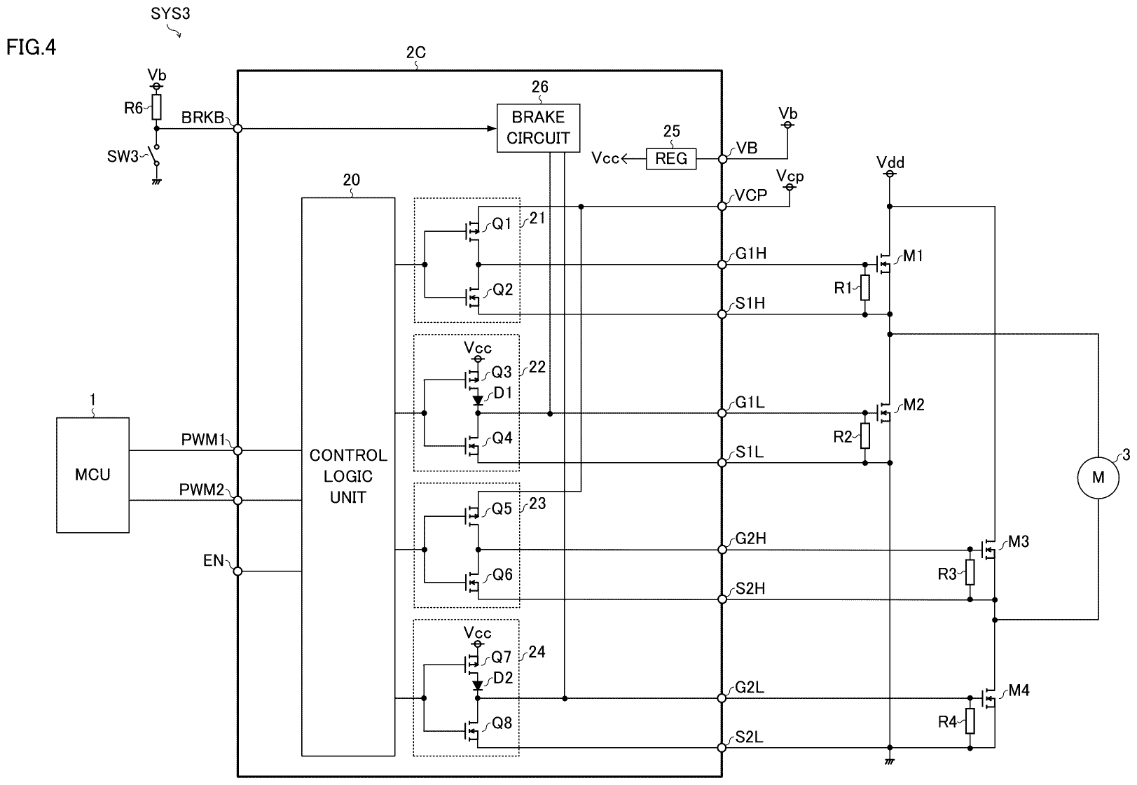

FIG. 4 is a diagram showing a schematic configuration of a motor system according to a third embodiment. This motor system SYS3 shown in FIG. 4 includes the MCU 1, a gate drive device 2C, the first half-bridge circuit including the switching devices M1 and M2, the second half-bridge circuit including the switching devices M3 and M4, and the motor 3. The motor system SYS3 shown in FIG. 4 further includes the resistors R1 to R4, a resistor R6, and a switch SW3. A motor drive circuit that is constituted by the gate drive device 2C, the first half-bridge circuit, and the second half-bridge circuit drives the motor 3.

The gate drive device 2C is basically the same as the gate drive device 2A except for including a terminal BRKB and a brake circuit 26. The brake circuit 26 is a circuit corresponding to the resistor R5, the switch SW1, and the switch SW2 in the first embodiment.

A brake control signal is supplied to the terminal BRKB. The resistor R6 and the switch SW3 are an example of a circuit that generates the brake control signal. The voltage Vb is applied to a first end of the resistor R6. On an outside of the gate drive device 2C, a second end of the resistor R6 and a first end of the switch SW3 are connected to the terminal BRKB. A second end of the switch SW3 is connected to the ground potential.

In this embodiment, under a state in which the brake control signal has been at the low level, the short brake is applied to the motor 3. Thus, at the time of the application of the short brake to the motor 3, the switch SW3 is controlled to be turned on. Note that, unlike in this embodiment, the short brake may be applied to the motor 3 under a state in which the brake control signal has been at the high level.

Under the state in which the brake control signal has been at the low level, the brake circuit 26 allows current to flow into the gate of each of the switching devices M2 and M4. Meanwhile, under the state in which the brake control signal has been at the high level, the brake circuit 26 does not allow the current to flow into the gate of each of the switching devices M2 and M4.

Also in this embodiment, as in the first embodiment and the second embodiment, the diode D1 prevents the flow of the current from the terminal G1L to the internal power-supply circuit 25 via the body diode of the switching device Q3. With this, the current consumption at the time of the application of the short brake to the motor 3 is reduced. Similarly, the diode D2 prevents the flow of the current from the terminal G2L to the internal power-supply circuit 25 via the body diode of the switching device Q7. With this, the current consumption at the time of the application of the short brake to the motor 3 is reduced.

Note that, the modifications of the first embodiment are applicable also to this embodiment. In addition, changes similar to changes from the first embodiment to the second embodiment may be made also to this embodiment.

### Fourth Embodiment

FIG. 5 is a diagram showing a schematic configuration of a motor system according to a fourth embodiment. This motor system SYS4 shown in FIG. 5 includes the MCU 1, a gate drive device 2D, the first half-bridge circuit including the switching devices M1 and M2, the second half-bridge circuit including the switching devices M3 and M4, and the motor 3. The motor system SYS4 shown in FIG. 5 further includes the resistors R1 to R4, the resistor R6, and the switch SW3. A motor drive circuit that is constituted by the gate drive device 2D, the first half-bridge circuit, and the second half-bridge circuit drives the motor 3.

The gate drive device 2D is basically the same as the gate drive device 2A except for including the terminal BRKB, the brake circuit 26, and diodes D3 and D4. The brake circuit 26 is the circuit corresponding to the resistor R5, the switch SW1, and the switch SW2 in the first embodiment. Anodes of the diodes D3 and D4 are connected to output ends of the brake circuit 26. In the gate drive device 2D, a cathode of the diode D3 is connected to the terminal G1L, the cathode of the diode D1, and the drain of the switching device Q4. A cathode of the diode D4 is connected to the terminal G2L, the cathode of the diode D2, and the drain of the switching device Q8.

The brake control signal is supplied to the terminal BRKB. The resistor R6 and the switch SW3 are an example of the circuit that generates the brake control signal. The voltage Vb is applied to the first end of the resistor R6. On an outside of the gate drive device 2D, the second end of the resistor R6 and the first end of the switch SW3 are connected to the terminal BRKB. The second end of the switch SW3 is connected to the ground potential.

In this embodiment, under the state in which the brake control signal has been at the low level, the short brake is applied to the motor 3. Thus, at the time of the application of the short brake to the motor 3, the switch SW3 is controlled to be turned on. Note that, unlike in this embodiment, the short brake may be applied to the motor 3 under the state in which the brake control signal has been at the high level.

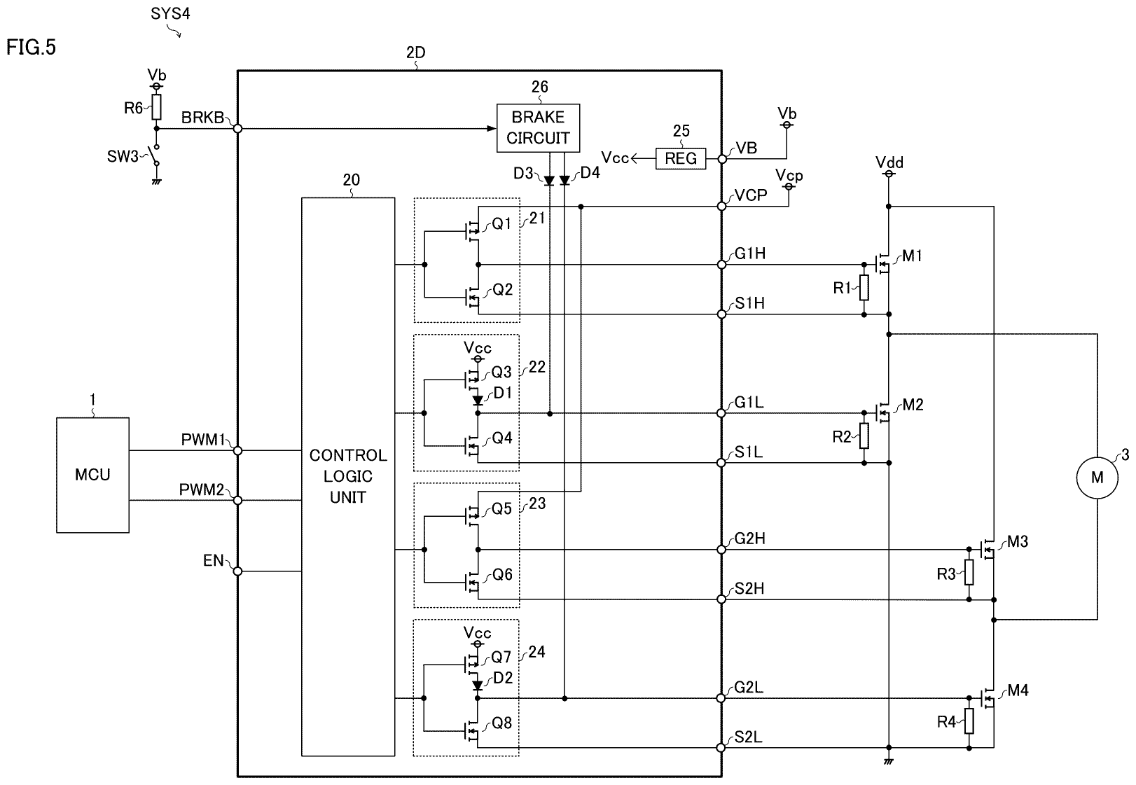

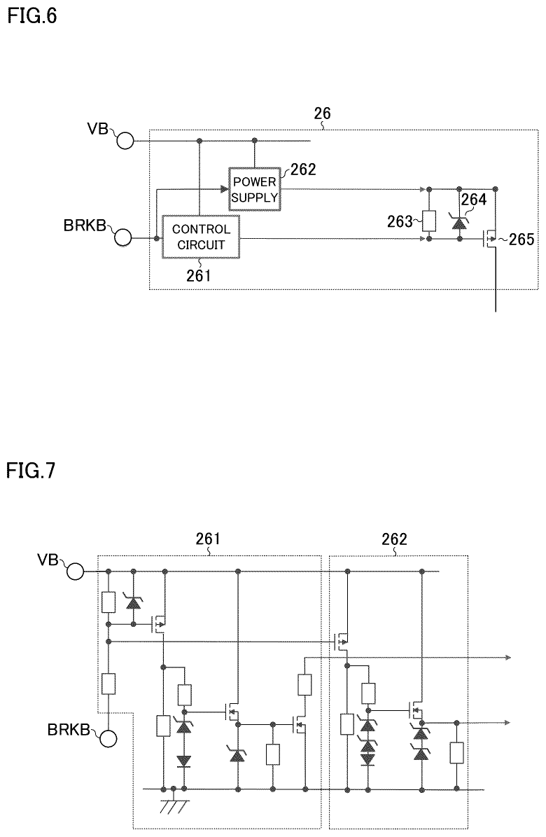

Under the state in which the brake control signal has been at the low level, the brake circuit 26 allows the current to flow into the gate of each of the switching devices M2 and M4. Meanwhile, under the state in which the brake control signal has been at the high level, the brake circuit 26 does not allow the current to flow into the gate of each of the switching devices M2 and M4. In addition, in this embodiment, under the state in which the brake control signal has been at the high level, voltage to be output from a power supply 262 (shown in FIG. 6 and FIG. 7 to be referred to below) in the brake circuit 26 is 0 V.

Without the diodes D3 and D4, under a state in which the brake control signal has been at the high level and in which high-level signals have been output from the gate drive circuits 22 and 24, current flows from the gate drive circuits 22 and 24 to the brake circuit 26. In this embodiment, the diodes D3 and D4 are provided. Thus, even under the state in which the brake control signal has been at the high level and in which the high-level signals have been output from the gate drive circuits 22 and 24, it is possible to prevent the flow of the current from the gate drive circuits 22 and 24 to the brake circuit 26.

Also in this embodiment, as in the first to the third embodiment, the diode D1 prevents the flow of the current from the terminal G1L to the internal power-supply circuit 25 via the body diode of the switching device Q3. With this, the current consumption at the time of the application of the short brake to the motor 3 is reduced. Similarly, the diode D2 prevents the flow of the current from the terminal G2L to the internal power-supply circuit 25 via the body diode of the switching device Q7. With this, the current consumption at the time of the application of the short brake to the motor 3 is reduced.

FIG. 6 is a diagram showing an example of a configuration of the brake circuit 26 to be used in the embodiments of the present disclosure. The brake circuit 26 shown in FIG. 6 includes a control circuit 261, the power supply 262, a resistor 263, a Zener diode 264, and a switch 265. The switch 265 is a P-channel MOSFET. The switch 265 is interposed between the power supply 262 and the diodes D3 and D4 (not shown in FIG. 6).

The control circuit 261 and the power supply 262 use the voltage Vb to be applied to the terminal VB as a power-supply voltage. Thus, the control circuit 261 and the power supply 262 are operable even when the internal power-supply circuit 25 is in the disabled state.

In response to the brake control signal to be supplied to the terminal BRKB, the control circuit 261 switches on/off the switch 265. Specifically, the control circuit 261 turns on the switch 265 under the state in which the brake control signal has been at the low level, and turns off the switch 265 under the state in which the brake control signal has been at the high level.

The power supply 262 is configured to be switched on/off in response to the brake control signal to be supplied to the terminal BRKB. Specifically, the power supply 262 is turned on (enabled state) under the state in which the brake control signal has been at the low level, and is turned off (disabled state) under the state in which the brake control signal has been at the high level. With this, it is possible to reduce power consumption of the brake circuit 26 at a time when the short brake is not applied to the motor 3, that is, under the state in which the brake control signal has been at the high level.

FIG. 7 is a diagram showing an example of configurations of the control circuit 261 and the power supply 262 of the brake circuit 26 shown in FIG. 6. The control circuit 261 and the power supply 262 shown in FIG. 7 are each constituted by resistors, MOSFETs, Zener diodes, and a diode.

Note that, the modifications of the first embodiment are applicable also to this embodiment. In addition, the changes similar to the changes from the first embodiment to the second embodiment may be made also to this embodiment.

### Application Example

FIG. 8 is a view illustrating an exterior appearance of a vehicle. This vehicle X1 illustrated in FIG. 8 includes the motor system according to any of the above-described embodiments or the modifications thereof.

The motor systems according to the above-described embodiments or the modifications thereof are applicable to various in-vehicle systems to be provided to the vehicle X1. Herein, an example of applying the motor system to a power window system as an example of the in-vehicle systems is described.

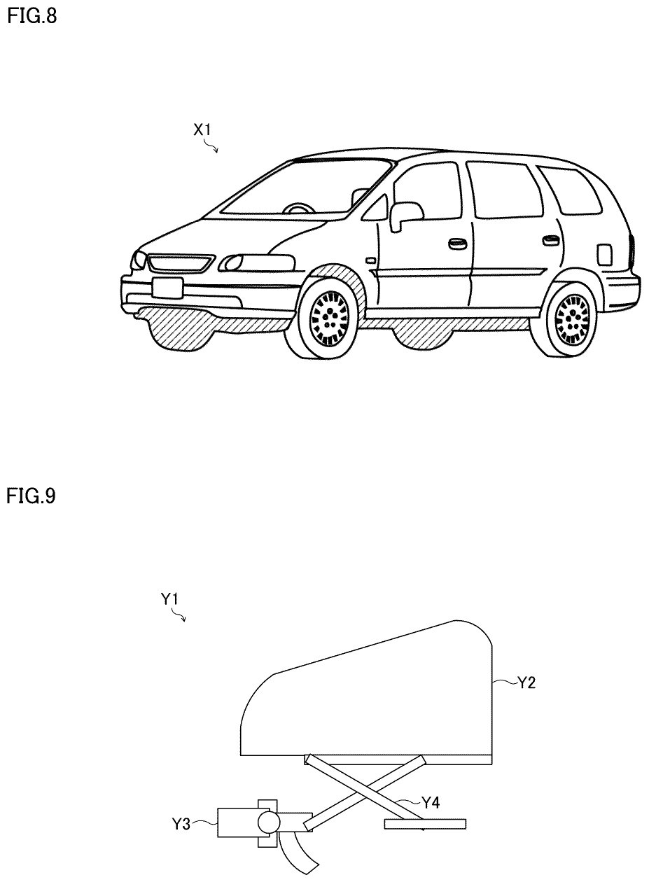

FIG. 9 is a schematic view illustrating an example of a configuration of the power window system to which the motor systems are applied. This power window system Y1 illustrated in FIG. 9 is a system for actuating a window Y2, and includes this window Y2, a motor system Y3, and a regulator Y4.

The regulator Y4 is a regulator of what is called an arm type, that is, a mechanism that moves up/down the window Y2 by rotation drive of a motor included in the motor system Y3. Note that, other regulators such as a regulator of what is called a wire type also may be employed. The window Y2 includes windows Y2 that are arranged, for example, at the front and the back on both lateral sides of the vehicle X1.

A position in an upper-and-lower direction of the window Y2 is adjusted by the rotation drive of the motor included in the motor system Y3. Then, the motor included in the motor system Y3 enters a short-brake state to fix the position of the window Y2. During most of the time when the vehicle X1 is driven, the motor included in the motor system Y3 is in the short-brake state. In addition, also while parking, the motor included in the motor system Y3 is in the short-brake state. In this state, the position of the window Y2 is fixed, and hence crime deterrent effect can be enhanced.

The motor systems according to the above-described embodiments or the modifications thereof are applicable also to various other in-vehicle systems such as a power sunroof system and a power sliding-door system. The in-vehicle systems utilize power that is output from a battery to be installed in the vehicle X1. Thus, the motor systems according to the above-described embodiments or the modifications thereof, the motor systems being capable of reducing current consumption, are especially useful.

The in-vehicle systems to which the motor systems according to the above-described embodiments or the modifications thereof are applicable enable omission of a locking mechanism for restraining movement of components such as windows. Thus, cost reduction and downsizing can be achieved.

The motor systems according to the above-described embodiments or the modifications thereof, the motor systems being capable of reducing current consumption, are especially useful not only in the in-vehicle systems but also in systems which cannot utilize a commercial power supply and in which positions of components that are movable by the rotation drive of the motor need to be locked.

Systems to which the motor systems according to the above-described embodiments or the modifications thereof are applied are not limited to the systems which cannot utilize the commercial power supply. The motor systems according to the above-described embodiments or the modifications thereof are applicable, for example, to a louver-position adjustment system for air conditioners and a shutter opening-and-closing system.

### Others

The configurations disclosed herein may be implemented as in the above-described embodiments, or may be variously modified within the gist of the present disclosure. All the features of the above-described embodiments are merely examples, and hence should not be regarded as limitations. It should be understood that the technical scope of the present disclosure is defined not by the above-described embodiments but by the scope of claims, and encompasses meaning of equivalents of the elements described in the scope of claims and all modifications within the scope of claims.

For example, the motor being a two-phase motor in the above-described embodiments may be a three-phase motor. Also when the motor is the three-phase motor, there are no problems as long as the motor system includes three half-bridge circuits.

### Appendix

Now, an appendix of the present disclosure, specifically, an appendix of specific configuration examples that are described in the above-described embodiments is provided.

A gate drive circuit (22, 24) according to the present disclosure has a configuration (first configuration) that drives a gate of a second switching device (M2, M4) in a motor drive circuit (2A to 2D, M1 to M4),
the motor drive circuit including a plurality of half-bridge circuits each including a first switching device (M1, M3), and
the second switching device
   that is connected in series to the first switching device and
   that is provided on a low-potential side relative to the first switching device,
the motor drive circuit being configured to drive a motor (3),
the gate drive circuit including:
   a current source unit (Q3, D1, Q7, D2) that is configured to allow current to flow into the gate of the second switching device; and
   a current sink unit (Q4, Q8) that is configured to draw current from the gate of the second switching device,
in which the current source unit includes a first diode (D1, D2) that is provided with an orientation in which a cathode of the first diode is directed to a side where the gate of the second switching device is present.

According to the gate drive circuit that has the first configuration, it is possible to prevent flow of the current via the current source unit at a time of application of a short brake to the motor. With this, current consumption at the time of the application of the short brake to the motor is reduced.

A gate drive device (2A to 2D) according to the present disclosure has a configuration (second configuration) including:
the gate drive circuit that has the first configuration; and
a first-switching-device gate drive circuit (21, 23) that is configured to drive a gate of the first switching device.

The gate drive device that has the second configuration may have a configuration (third configuration) including
a brake circuit (26) that is configured to allow current to flow into the gate of the second switching device in response to a brake control signal.

The gate drive device that has the third configuration may have a configuration (fourth configuration) including
a second diode (D3, D4),
in which the second diode is interposed between the brake circuit and the gate of the second switching device with an orientation in which a cathode of the second diode is directed to the side where the gate of the second switching device is present, and
in which the brake circuit includes a power supply (262) that is configured to be switched on/off in response to the brake control signal.

The gate drive device that has the fourth configuration may have a configuration (fifth configuration)
in which the brake circuit includes a switch (265), and
in which the switch
   is interposed between the power supply and the second diode, and
   is configured to be subjected to on/off control in response to the brake control signal.

The gate drive device that has any of the second to the fifth configurations may have a configuration (sixth configuration) in which the gate drive device is a semiconductor integrated-circuit device.

A motor system (SYS1 to SYS4) according to the present disclosure has a configuration (seventh configuration) including:
the gate drive device that has any of the second to the sixth configurations;
the motor drive circuit; and
the motor.

A vehicle (X1) according to the present disclosure has a configuration (eighth configuration) including the motor system that has the seventh configuration.

In a current-consumption reducing method according to the present disclosure,
a motor drive circuit (2A to 2D, M1 to M4) includes a plurality of half-bridge circuits each including
   a first switching device (M1, M3), and
   a second switching device (M2, M4)
      that is connected in series to the first switching device and
      that is provided on a low-potential side relative to the first switching device,
the motor drive circuit is configured to drive a motor (3), and
the current-consumption reducing method includes providing a diode (D1, D2) in a current source unit (Q3, D1, Q7, D2) that is configured to allow current to flow into a gate of the second switching device, the diode being provided with an orientation in which a cathode of the diode is directed to a side where the gate of the second switching device is present, thereby reducing current consumption at a time of application of a short brake to the motor.

Also according to the current-consumption reducing method of the present disclosure, it is possible to prevent the flow of the current via the current source unit at the time of the application of the short brake to the motor. With this, the current consumption at the time of the application of the short brake to the motor is reduced.

What is claimed is:

1. A gate drive circuit that is configured to drive a gate of a second switching device in a motor drive circuit
the motor drive circuit including a plurality of half-bridge circuits each including
a first switching device, and
the second switching device
that is connected in series to the first switching device and
that is provided on a low-potential side relative to the first switching device,
the motor drive circuit being configured to drive a motor,
the gate drive circuit comprising:
a current source unit that is configured to allow current to flow into the gate of the second switching device; and
a current sink unit that is configured to draw current from the gate of the second switching device,
wherein the current source unit includes a first diode that is provided with an orientation in which a cathode of the first diode is directed to a side where the gate of the second switching device is present.

2. A gate drive device, comprising:
the gate drive circuit according to claim 1; and
a first-switching-device gate drive circuit that is configured to drive a gate of the first switching device.

3. The gate drive device according to claim 2, further comprising
a brake circuit that is configured to allow current to flow into the gate of the second switching device in response to a brake control signal.

4. The gate drive device according to claim 3, further comprising
a second diode,
wherein the second diode is interposed between the brake circuit and the gate of the second switching device with an orientation in which a cathode of the second diode is directed to the side where the gate of the second switching device is present, and
wherein the brake circuit includes a power supply that is configured to be switched on/off in response to the brake control signal.

5. The gate drive device according to claim 4,
wherein the brake circuit includes a switch, and
wherein the switch
is interposed between the power supply and the second diode, and
is configured to be subjected to on/off control in response to the brake control signal.

6. The gate drive device according to claim 2,
wherein the gate drive device is a semiconductor integrated-circuit device.

7. A motor system, comprising:
the drive device according to claim 2;
the motor drive circuit; and
the motor.

8. A motor system, comprising:
the gate drive device according to claim 3;
the motor drive circuit; and
the motor.

9. A motor system, comprising:
the gate drive device according to claim 4;
the motor drive circuit; and
the motor.

10. A motor system, comprising:
the gate drive device according to claim 5;
the motor drive circuit; and
the motor.

11. A motor system, comprising:
the gate drive device according to claim 6;
the motor drive circuit; and
the motor.

12. A vehicle, comprising
the motor system according to claim 7.

13. A vehicle, comprising
the motor system according to claim 8.

14. A vehicle, comprising
the motor system according to claim 9.

15. A vehicle, comprising
the motor system according to claim 10.

16. A vehicle, comprising
the motor system according to claim 11.

17. A current-consumption reducing method,
in which a motor drive circuit includes a plurality of half-bridge circuits each including
a first switching device, and
a second switching device
that is connected in series to the first switching device and
that is provided on a low-potential side relative to the first switching device, and
in which the motor drive circuit is configured to drive a motor,
the current-consumption reducing method including providing a diode in a current source unit that is configured to allow current to flow into a gate of the second switching device, the diode being provided with an orientation in which a cathode of the diode is directed to a side where the gate of the second switching device is present, thereby reducing current consumption at a time of application of a short brake to the motor.
